(19) United States
(12) Patent Application Publication
(10) Pub. No.: US 2026/0302273 A1
(43) Pub. Date: Oct. 1, 2026

(54) FUEL CELL STACK

(71) Applicant: Honda Motor Co., Ltd., Tokyo (JP)

(72) Inventors: Shun Hattori, Saitama (JP); Kenta Watanabe, Saitama (JP)

(21) Appl. No.: 19/630,727

(22) Filed: Mar. 27, 2026

(30) Foreign Application Priority Data
Mar. 28, 2025 (JP) 2025-056684

(51) Int. Cl. H01M 8/0267; H01M 8/04029; H01M 8/1004; H01M 8/10

(52) U.S. Cl. CPC H01M 8/0267; H01M 8/04029; H01M 8/1004; H01M 2008/1095

(57) ABSTRACT

A fuel cell stack being configured by alternately stacking a membrane electrode structure and a separator in a predetermined direction. The separator includes a first plate member having a first surface and a first opposite surface and a second plate member having a second surface and a second opposite surface, and formed in a concave-convex shape to form a cooling flow path between the first and second opposite surfaces and to form gas flow paths with the membrane electrode structure, the gas flow path include a first gas flow path facing a membrane electrode assembly, a second gas flow path extending from a communication hole, and a third gas flow path between the first and second gas flow paths, and the third gas flow path includes a plurality of protruding portions extending from the first surface and the second surface toward the membrane electrode structure.

### CROSS-REFERENCE TO RELATED APPLICATION

This application is based upon and claims the benefit of priority from Japanese Patent Application No. 2025-056684 filed on Mar 28, 2025, the content of which is incorporated herein by reference.

### BACKGROUND OF THE INVENTION

### Field of the Invention

This invention relates to a fuel cell stack.

### DESCRIPTION OF THE RELATED ART

In recent years, technological developments have been made on a fuel cell that contribute to energy efficiency in order to ensure access to energy that is affordable, reliable, sustainable and advanced by more people. As a conventional technology related to this type of fuel cell, a fuel cell has been known in which a pair of separators is provided with a plurality of linear protrusions extending radially from communication holes that supply or discharge reaction gas to a flow path region where power generation is performed. Such a fuel cell is described in, for example, Japanese Unexamined Patent Publication No. 2022-146434 (JP2022-146434A). In the fuel cell described in JP2022-146434A, a flow path through which a cooling medium flows is formed between a pair of separators, and the pair of separators abut against each other at branching portions and merging portions of the reaction gas between the end of the flow path region and the ends of the linear protrusions.

However, in the fuel cell described in JP2022-146434A, since the pair of separators abut at the branching portions and merging portions of the reaction gas, the flow of the cooling medium is obstructed, and air contained in the cooling medium may stagnate, thereby impairing the cooling effect.

### SUMMARY OF THE INVENTION

An aspect of the present invention is a fuel cell stack configured by alternately stacking a membrane electrode structure and a separator in a predetermined direction. The membrane electrode structure includes a membrane electrode assembly having an electrolyte membrane and electrodes, and a frame member supporting a peripheral portion of the membrane electrode assembly, the separator includes a first plate member having a first surface and a first opposite surface, and a second plate member having a second surface and a second opposite surface facing the first opposite surface, and is configured to form a cooling flow path through which a cooling medium flows between the first opposite surface and the second opposite surface, the first plate member and the second plate member are configured in a concave-convex shape so as to form gas flow paths through which a reaction gas flows between the first surface and the membrane electrode structure and between the second surface and the membrane electrode structure, respectively, from a first communication hole on one end side of the separator penetrating the separator to a second communication hole on another end side of the separator penetrating the separator, each of the gas flow paths includes a first gas flow path facing the membrane electrode assembly, a second gas flow path extending from the first communication hole toward an inlet of the first gas flow path or from the second communication hole toward an outlet of the first gas flow path, and a third gas flow path between the first gas flow path and the second gas flow path, and the third gas flow path includes a plurality of protruding portions protruding from the first surface and the second surface toward the membrane electrode structure, respectively, in a state where the first opposite surface and the second opposite surface are separated from each other.

### BRIEF DESCRIPTION OF THE DRAWINGS

The objects, features, and advantages of the present invention will become clearer from the following description of embodiments in relation to the attached drawings, in which:

FIG. 1 is a perspective view schematically illustrating an overall configuration of a fuel cell stack according to an embodiment of the present invention;

FIG. 2 is a cross-sectional view taken along line II-II of FIG. 1;

FIG. 3 is a perspective view schematically illustrating a configuration of a unitized electrode assembly included in the fuel cell stack of FIG. 1;

FIG. 4 is a front view of a separator included in the fuel cell stack of FIG. 1;

FIG. 5 is an enlarged view of part V in FIG. 4;

FIG. 6 is a diagram illustrating a configuration of a guide portion in an end of the separator in FIG. 4 in an overlapping manner;

FIG. 7 is a cross-sectional view taken along line VII-VII of FIG. 4; and

FIG. 8 is a cross-sectional view taken along line VIII-VIII of FIG. 6.

### DETAILED DESCRIPTION OF THE INVENTION

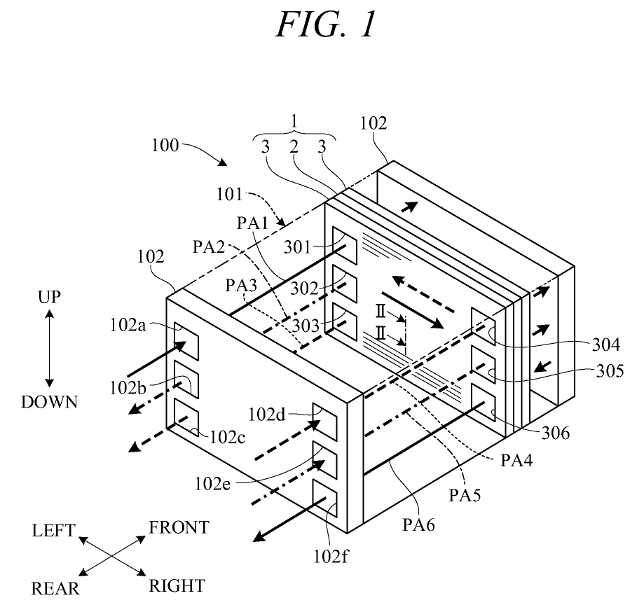

Hereinafter, embodiments of the present invention will be described with reference to FIGS. 1 to 8. A fuel cell stack according to an embodiment of the present invention is a main component of a fuel cell and constitutes a main body of the fuel cell. The fuel cell can be mounted on a vehicle, for example, and is capable of generating electric power for actuating the vehicle. First, the overall configuration of the fuel cell stack is schematically explained. The fuel cell stack may be simply referred to as a fuel cell.

FIG. 1 is a perspective view schematically illustrating an overall configuration of a fuel cell stack 100 according to an embodiment of the present invention. Hereinafter, for the sake of convenience, three-axis directions orthogonal to one another as illustrated in the drawings are defined as a front-rear direction, a left-right direction, and an up-down direction, and a configuration of each unit will be described in accordance with such definitions. The downward direction in the up-down direction corresponds to the direction of gravity or substantially the direction of gravity. The front-rear direction corresponds to a stacking direction of the fuel cell stack 100. The front-rear direction and the left-right direction are not necessarily the same as the front-rear direction and the left-right direction of the vehicle.

As illustrated in FIG. 1, the fuel cell stack 100 includes a cell stacked body 101 configured by stacking a plurality of power generation cells 1 in the front-rear direction and end units 102 disposed at both end portions of the cell stacked body 101 in the front-rear direction, and the whole exhibits a substantially rectangular parallelepiped shape. Although not illustrated, the periphery of the cell stacked body 101 is covered by a substantially rectangular parallelepiped-shaped case. The length of the cell stacked body 101 in the left-right direction is longer than the length in the up-down direction. Therefore, the left-right direction is the longitudinal direction, and the up-down direction is the short direction. In FIG. 1, a single power generation cell 1 is shown for convenience.

The power generation cell 1 has a unitized electrode assembly 2 (hereinafter referred to as UEA) having a joined body including an electrolyte membrane and electrodes, and separators 3 disposed on both sides of the UEA 2 in the front-rear direction and sandwiching the UEA 2. The UEA 2 and the separators 3 are alternately arranged in the front-rear direction. The UEA 2 can also be referred to as a membrane electrode structure or a membrane electrode member.

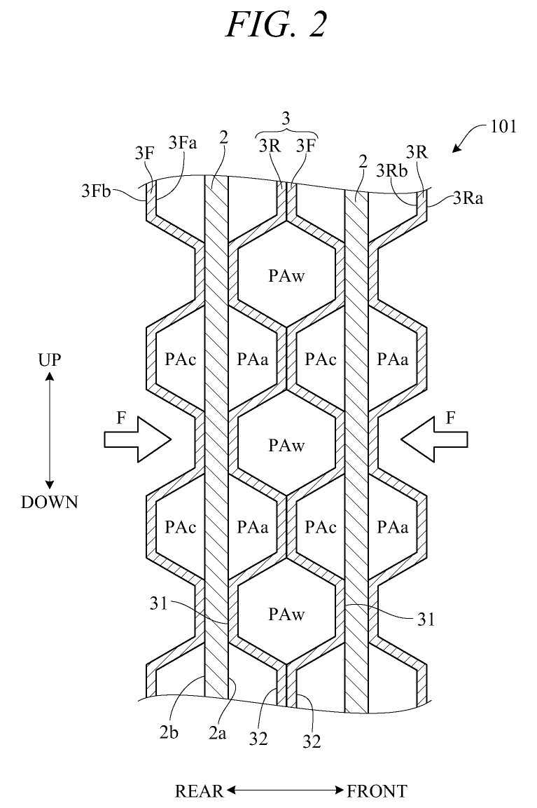

FIG. 2 is a cross-sectional view of a main part in a power generation region at the center of the cell stacked body 101 in the left-right direction (a cross-sectional view along line II-II in FIG. 1). As shown in FIG. 2, the separator 3 has a front plate 3F and a rear plate 3R, which are a pair of front and rear metallic thin plates having a corrugated cross-section. The front plate 3F extends in the up-down and left-right directions and has a front surface 3Fa and a rear surface 3Fb. The rear plate 3R extends in the up-down and left-right directions and has a front surface 3Ra and a rear surface 3Rb. The rear surface 3Fb of the front plate 3F and the front surface 3Ra of the rear plate 3R facing each other are joined at their outer peripheral edge portions by welding or the like. As a result, the front plate 3F and the rear plate 3R are integrally joined together. A conductive material having excellent corrosion resistance is used for the separator 3, and for example, stainless steel, titanium, titanium alloy, or the like can be used.

Inside the separator 3 surrounded by the front plate 3F and the rear plate 3R, that is, between the rear surface 3Fb of the front plate 3F and the front surface 3Ra of the rear plate 3R, a cooling flow path PAw through which a cooling medium flows is formed. The power generation surface of the power generation cell 1 is cooled by the flow of the cooling medium. As the cooling medium, for example, water can be used. The surfaces of the separator 3 facing the UEA 2 (the front surface 3Fa and the rear surface 3Rb) are configured in an uneven shape by press forming or the like so as to form gas flow paths with the UEA 2. More specifically, the separator 3 has a pair of front and rear convex portions 31 protruding toward the UEA 2 and a pair of front and rear concave portions 32 configured in a concave shape continuous with the pair of front and rear convex portions 31.

The pair of front and rear convex portions 31 abuts against the rear surface 2b and the front surface 2a of the UEA 2. A compressive load F is applied to the cell stacked body 101 in the front-rear direction during assembly of the fuel cell stack 100, and this compressive load F is maintained after completion of assembly of the fuel cell stack 100. Therefore, a predetermined surface pressure due to the compressive load F acts on the UEA 2 in the front-rear direction via the convex portions 31.

Between the front surface 2a of the UEA 2 and the rear plate 3R of the separator 3 facing the front surface 2a, an anode flow path PAa through which fuel gas flows is formed by the concave portion 32. Between the rear surface 2b of the UEA 2 and the front plate 3F of the separator 3 facing the rear surface 2b, a cathode flow path PAc through which oxidant gas flows is formed by the concave portion 32. The fuel gas is a gas containing hydrogen, and for example, hydrogen gas can be used. The oxidant gas is a gas containing oxygen, and for example, air can be used. Without distinguishing between the fuel gas and the oxidant gas, these may be referred to as reaction gas.

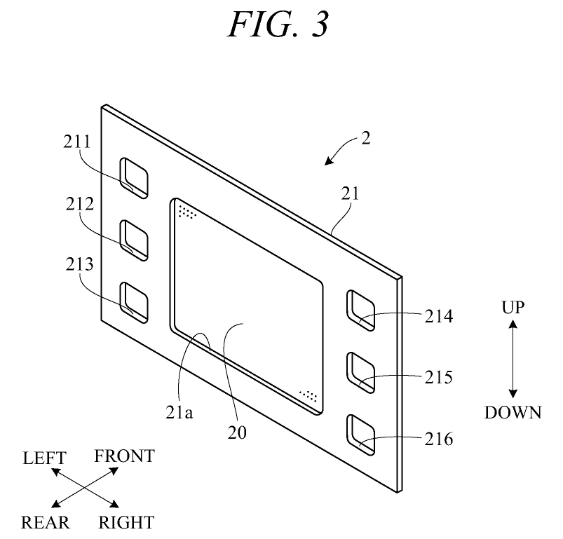

FIG. 3 is a perspective view illustrating a schematic configuration of the UEA 2. As shown in FIG. 3, the UEA 2 has a membrane electrode assembly (hereinafter referred to as MEA) 20 having a substantially rectangular shape and a frame 21 that supports the MEA 20. The MEA 20 has an electrolyte membrane, an anode electrode provided on a front surface of the electrolyte membrane, and a cathode electrode provided on a rear surface of the electrolyte membrane.

The electrolyte membrane is, for example, a solid polymer electrolyte membrane, and a thin film of perfluorosulfonic acid polymer containing moisture can be used. Not only a fluorine-based electrolyte but also a hydrocarbon-based electrolyte can be used. The anode electrode has an electrode catalyst layer formed on the front surface of the electrolyte membrane and serving as a reaction field for electrode reactions, and a gas diffusion layer provided on the front surface of the electrode catalyst layer and diffusing and supplying the fuel gas. The cathode electrode has an electrode catalyst layer formed on the rear surface of the electrolyte membrane and serving as a reaction field for electrode reactions, and a gas diffusion layer provided on the rear surface of the electrode catalyst layer and diffusing and supplying the oxidant gas.

In the anode electrode, the fuel gas (hydrogen) supplied through the anode flow path PAa in FIG. 2 is ionized by an action of the catalyst and moves to the cathode electrode side through the electrolyte membrane. Electrons generated at this time pass through an external circuit and are extracted as electric energy. In the cathode electrode, the oxidant gas (oxygen) supplied through the cathode flow path PAc in FIG. 2 reacts with hydrogen ions guided from the anode electrode and electrons moved from the anode electrode, and water is generated. The generated water (referred to as generated water) provides appropriate humidity to the electrolyte membrane 23, and excess water is discharged to the outside of the UEA 2 along the gas flow.

As illustrated in FIG. 3, the frame 21 is a substantially rectangular frame-shaped member and is configured by a sheet material or film material of insulating resin, rubber, or the like. The frame 21 can also be referred to as a sheet or film. A substantially rectangular opening 21a is provided in the central portion of the frame 21. The MEA 20 is provided so as to cover the entire opening 21a, and the peripheral portion of the MEA 20 is supported by the frame 21.

On the left side of the opening 21a of the frame 21, three through-holes 211 to 213 penetrating the frame 21 in the front-rear direction are opened side by side in the up-down direction. On the right side of the opening 21a, three through-holes 214 to 216 penetrating the frame 21 in the front-rear direction are opened side by side in the up-down direction. The through-holes 211 to 216 are all shown as substantially rectangular shapes for convenience, but the shapes and arrangements of the through-holes 211 to 216 are not limited to this.

As illustrated in FIG. 1, in the separators 3 in front of and behind the UEA 2, through-holes 301 to 306 penetrating the separators 3 in the front-rear direction are respectively opened at positions corresponding to the through-holes 211 to 216 of the frame 21. The through-holes 301 to 306 communicate with the through-holes 211 to 216 of the frame 21, respectively. By the collection of these mutually communicating through-holes 211 to 216 and 301 to 306, flow paths PA1 to PA6 (indicated by arrows for convenience) extending in the front-rear direction through the cell stacked body 101 are formed. The flow paths PA1 to PA6 are sometimes referred to as manifolds. The flow paths PA1 to PA6 are connected to manifolds external to the fuel cell stack 100.

Although not illustrated, the end units 102 at the front and rear of the cell stacked body 101 each have a plurality of plates disposed to overlap in the front-rear direction. That is, the end unit 102 has a terminal plate disposed adjacent to the cell stacked body 101, an insulating plate disposed on the outer side in the front-rear direction of the terminal plate, and an end plate disposed on the outer side in the front-rear direction of the insulating plate.

In the rear end unit 102, a plurality of through-holes 102a to 102f penetrating the end unit 102 in the front-rear direction are opened at positions corresponding to the through-holes 211 to 216 and 301 to 306 of the cell stacked body 101. The through-holes 102a to 102f are all shown as substantially rectangular shapes for convenience, but the positions and shapes of the through-holes 102a to 102f are not limited thereto.

The through-hole 102a is a fuel gas supply port, and fuel gas is supplied to the fuel cell stack 100 through the through-hole 102a. This fuel gas is guided to the anode flow path PAa between the UEA 2 and the rear plate 3R of the separator 3 through the through-holes 211 and 301. The fuel gas after passing through the anode flow path PAa flows rearward through the through-holes 216 and 306 and is discharged from the through-hole 102f.

The through-hole 102d is an oxidant gas supply port, and oxidant gas is supplied to the fuel cell stack 100 through the through-hole 102d. This oxidant gas is guided to the cathode flow path PAc between the UEA 2 and the front plate 3F of the separator 3 through the through-holes 214 and 304. The oxidant gas after passing through the cathode flow path PAc flows rearward through the through-holes 213 and 303 and is discharged from the through-hole 102c.

The through-hole 102e is a cooling medium supply port, and cooling medium is supplied to the fuel cell stack 100 through the through-hole 102e. This cooling medium is guided to the cooling flow path PAw between the front plate 3F and the rear plate 3R of the separator 3 through the through-holes 215 and 305. The cooling medium after passing through the cooling flow path PAw flows rearward through the through-holes 212 and 302 and is discharged from the through-hole 102b. The above is the schematic constitution of the fuel cell stack 100.

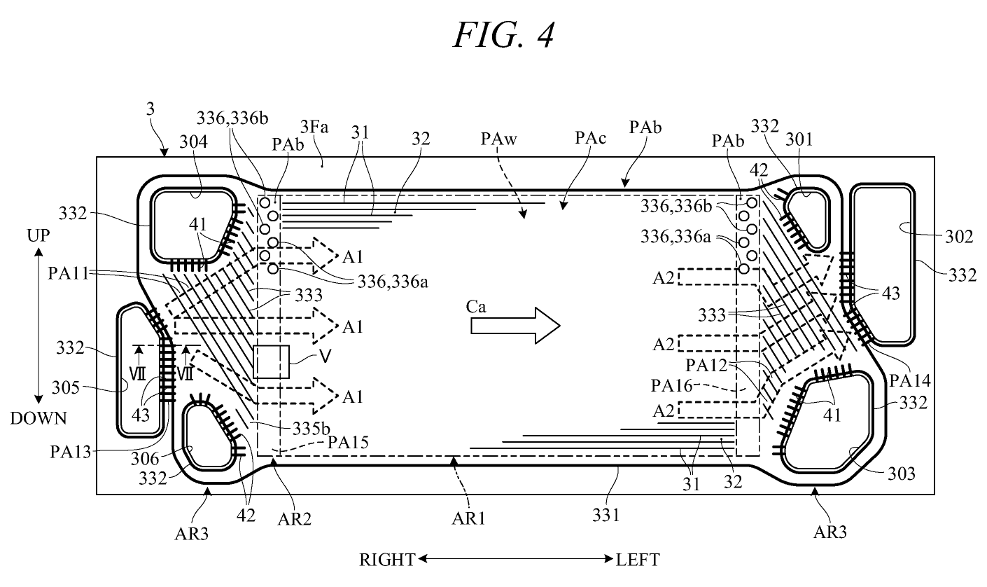

The configuration of the separator 3 will be described in more detail. FIG. 4 is a front view (view viewed from the front side) of the separator 3, and the left-right direction is inverted with respect to FIG. 1. That is, FIG. 4 is a view showing the front surface 3Fa (FIG. 2) of the separator 3 facing the cathode electrode of the rear surface 2b of the UEA 2, and illustrates the shape of the separator 3 in plan view as viewed from the thickness direction.

In FIG. 4, the shape and arrangement of the through-holes 301 to 306 are slightly changed from those in FIG. 1. Specifically, the through-holes 302 and 305 through which the cooling medium passes are disposed on the outer side in the left-right direction than the through-holes 301 and 306 through which the fuel gas passes and the through-holes 303 and 304 through which the oxidant gas passes. Furthermore, the lower end portion of the through-hole 305 is located below the upper end portion of the through-hole 306, and the upper end portion of the through-hole 302 is located above the lower end portion of the through-hole 301. A positioning portion (e.g., an engagement concave portion) for positioning the separator 3 is provided in the peripheral edge portion of the separator 3, but illustration thereof is omitted in FIG. 4.

In FIG. 4, a region that is a central region in the left-right direction and faces the MEA 20 of the UEA 2, that is, a region AR1 indicated by a two-dot chain line and faces the power generation surface is referred to as an active region of the separator 3. A region AR2 of a vertically long rectangular region (two-dot chain line) having a predetermined length in the left-right direction on the outer side in the left-right direction of the active region AR1 is referred to as a buffer region. A region AR3 on the outer side in the left-right direction of the buffer region AR2 is referred to as an inactive region. The inactive region AR3 of the separator 3 faces the frame 21 of the UEA 2. A boundary portion between the MEA 20 and the frame 21, that is, an end portion in the left-right direction of the MEA 20 is located in the buffer region AR2. The active region AR1 corresponds to a power generation region where power is generated.

As illustrated in FIGS. 2 and 4, in the active region AR1 of the separator 3 (front plate 3F), although illustration of one part is omitted, a plurality of convex portions 31 are provided to protrude toward the front side at equal intervals in the up-down direction over substantially the entire region. Each of the plurality of convex portions 31 extends in the left-right direction, and the concave portion 32 is provided between the convex portions 31 adjacent in the up-down direction. More specifically, although not illustrated, the plurality of convex portions 31 extend in the left-right direction while being curved in the up-down direction, and a wavy concave portion 32 in plan view is provided between the convex portions 31 adjacent in the up-down direction. Although not illustrated, the rear surface 3Rb of the rear plate 3R is also provided with a wavy concave portion 32 similarly to the front surface 3Fa of the front plate 3F. However, the phase of the wave is different between the concave portion 32 of the front surface 3Fa of the front plate 3F and the concave portion 32 of the rear surface 3Rb of the rear plate 3R by a predetermined phase (e.g., π). A cathode flow path PAc is formed between the plurality of concave portions 32 and the rear surface of the MEA 20. As indicated by an arrow Ca in FIG. 4, the oxidant gas flows from right to left in the cathode flow path PAc.

As illustrated in FIG. 4, the front surface 3Fa of the separator 3 (front plate 3F) is provided with a plurality of bead portions for sealing protruding out to the front side toward the frame 21, that is, metal bead seals. The plurality of bead portions include an outer bead portion 331 and a plurality of individual bead portions 332. The protrusion amounts to the front side of the plurality of bead portions are the same. The plurality of bead portions extend with a predetermined width, but in FIG. 4, the bead portion is indicated by a thick line for the sake of convenience. Although not illustrated, the plurality of bead portions are also provided on the rear plate 3R similarly to the front plate 3F.

The plurality of individual bead portions 332 are extended along the peripheral edge portions of the plurality of through-holes 301 to 306, and individually surround the plurality of through-holes 301 to 306. The outer bead portion 331 extends in the left-right direction above and below the active region AR1 along the upper edge portion and the lower edge portion of the separator 3, passes through the outer side in the left-right direction of the individual bead portion 332 at the periphery of the through-holes 301, 303, 304 and 306, and passes through the inner side in the left-right direction of the individual bead portion 332 at the periphery of the through-holes 302 and 305. The inner side in the left-right direction refers to the center side in the left-right direction of the separator 3, and the outer side in the left-right direction refers to the end portion side in the left-right direction of the separator 3.

In the inactive region AR3 of the separator 3 (front plate 3F), a plurality of guide portions 333 are provided to protrude toward the frame 21 on the front side, over the entire region in the up-down direction of the buffer region AR2 continuing to the right end inlet of the cathode flow path Pac from the through-hole 304. The plurality of guide portions 333 extend at equal intervals and substantially parallel to each other, and obliquely extend toward the lower left side. An oxidant gas supply flow path PA11 for supplying oxidant gas is formed in a space facing the frame 21 between the guide portions 333 adjacent in the up-down direction.

Furthermore, in the inactive region AR3 of the separator 3, a plurality of guide portions 333 are provided to protrude toward the frame 21 on the front side, over the through-hole 303 from the entire region in the up-down direction of the buffer region AR2 continuing to the left end outlet of the cathode flow path PAc. The plurality of guide portions 333 extend at equal intervals and substantially parallel to each other, and obliquely extend toward the lower left side. An oxidant gas discharge flow path PA12 for discharging oxidant gas is formed in a space facing the frame 21 between the guide portions 333 adjacent in the up-down direction.

The configurations of the buffer regions AR2 on the right side and the left side of the active region AR1 are equal to each other. In the buffer region AR2 of the separator 3 (front plate 3F), although the illustration of one part is omitted, a plurality of convex portions 336 having a substantially cylindrical shape are provided to protrude toward the front side over the entire region in the up-down direction, The plurality of convex portions 336 have the same shape and include a plurality of inner convex portions 336a arranged on the inner side in the left-right direction and a plurality of outer convex portions 336b arranged on the outer side in the left-right direction. The plurality of inner convex portions 336a and the plurality of outer convex portions 336b are both provided at equal intervals in the up-down direction. The distance between the pair of inner convex portions 335a adjacent in the up-down direction is equal to the distance between the pair of outer convex portions 336b adjacent in the up-down direction.

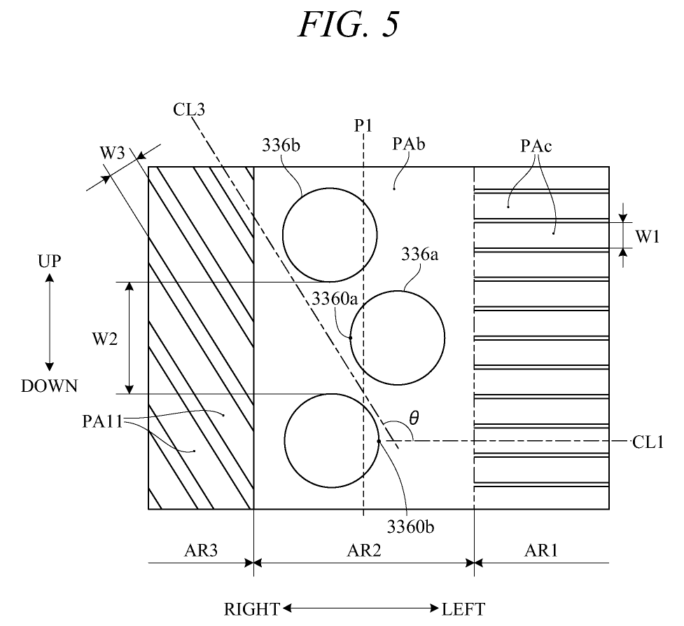

FIG. 5 is an enlarged view (enlarged view of portion V in FIG. 4) of the buffer region AR2 in FIG. 4. As illustrated in FIG. 5, the plurality of inner convex portions 336a and the plurality of outer convex portions 336b are provided with the positions shifted from each other in the up-down direction. More specifically, the inner convex portion 336a is provided at an intermediate position in the up-down direction of the pair of outer convex portions 336b adjacent in the up-down direction. In other words, the plurality of convex portions 336 are entirely arrayed in a staggered manner.

The outer end portion 3360a in the left-right direction of the inner convex portion 336a is located on the outer side in the left-right direction than the inner end portion 3360b in the left-right direction of the outer convex portion 336b. As a result, it is possible to shorten the length in the left-right direction of the buffer region AR2 having the convex portions 336 in the two left and right columns. The outer end portion 3360a in the left-right direction of the inner convex portion 336a and the inner end portion 3360b in the left-right direction of the outer convex portion 336b may be located at the same position in the left-right direction, and the outer end portion 3360a in the left-right direction of the inner convex portion 336a may be located on the inner side in the left-right direction than the inner end portion 3360b in the left-right direction of the outer convex portion 336b. The end portion in the left-right direction of the MEA 20 is located at, for example, the intermediate position P1 in the left-right direction of the buffer region AR2. In this case, the MEA 20 abuts on the front end face of the inner convex portion 336a.

The length between the inner convex portions 336a adjacent in the up-down direction and the length between the outer convex portions 336b adjacent in the up-down direction correspond to the width W3 of the flow path (buffer flow path PAb) of the oxidant gas in the buffer region AR2. The width W2 of the oxidant gas supply flow path PA11 in the inactive region AR3 is longer than the width W1 of the cathode flow path PAc in the active region AR1, but is shorter than the width W2 of the buffer flow path PAb in the buffer region AR2. In FIG. 5, an axis line CL3 parallel to the oxidant gas supply flow path PA11 obliquely intersects with an axis line CL1 parallel to the cathode flow path PAc at a predetermined angle θ greater than 90° and smaller than 180°. The predetermined angle θ is, for example, in a range of 120° to 150°.

As illustrated in FIG. 4, a plurality of tunnel portions 41 that traverse the individual bead portions 332 are provided to protrude toward the front side between the through-hole 304 and the guide portion 333 and between the through-hole 303 and the guide portion 333. The protrusion amount to the front side of the tunnel portion 41 is smaller than the protrusion amount to the front side of the individual bead portion 332. Although not illustrated, the tunnel portion 41 is also provided on the rear plate 3R symmetrically with the front plate 3F in the front-rear direction.

One end portion of the tunnel portion 41 communicates with the through-holes 303 and 304. The other end portion of the tunnel portion 41 communicates with a space on the front side of the separator 3 (front plate 3F) (a space between the separator 3 and the frame 21 on the front side thereof). In the inactive region AR3 on the right side, an oxidant gas supply flow path PA11 is formed between the guide portions 333 adjacent in the up-down direction. In the inactive region AR3 on the left side, an oxidant gas discharge flow path PA12 is formed between the guide portions 333 adjacent in the up-down direction. As a result, the through-hole 304 and the oxidant gas supply flow path PA11, and the through-hole 303 and the oxidant gas discharge flow path PA12 communicate with each other via the tunnel portion 41.

The separator 3 is further provided with a tunnel portion 42 extending from the through-holes 301 and 306 and a tunnel portion 43 extending from the through-holes 302 and 305. One end portion of the tunnel portion 42 communicates with the through-hole 301 and 306, and the other end portion thereof communicates with a space on the rear side of the separator 3 (rear plate 3R). One end portion of the tunnel portion 43 communicates with the through-holes 302 and 305, and the other end portion communicates with a space between the front plate 3F and the rear plate 3R (see FIG. 7). The metal bead seal (outer bead portion 331, individual bead portion 332), the guide portion 333, the convex portion 336, the tunnel portions 41 to 43, and the like are formed by press working the front plate 3F.

The oxidant gas supplied through the through-hole 304 passes through the tunnel portion 41 and flows to the inlet of the oxidant gas supply flow path PA11. Furthermore, the oxidant gas flows through the oxidant gas supply flow path PA11 to the left side or the diagonally lower left side along the guide portion 333, and flows into the buffer flow path PAb on the right side. The oxidant gas that has passed through the buffer flow path PAb flows into the cathode flow path PAc. The oxidant gas that flowed through the cathode flow path PAc flows into the buffer flow path PAb on the left side, passes through the buffer flow path PAb, and then flows to the inlet of the oxidant gas discharge flow path PA12. The oxidant gas further flows through the oxidant gas discharge flow path PA12 to the left side or the diagonally lower left side along the guide portion 333, passes through the tunnel portion 41, and flows to the through-hole 303.

The right guide portion 333 is provided so that the region of the oxidant gas supply flow path PA11 gradually expands in the up-down direction from the through-hole 304 to the buffer flow path PAb. The left guide portion 333 is also provided so that the region of the oxidant gas discharge flow path PA12 gradually expands in the up-down direction with the movement in the left-right direction from the through-hole 303 to the buffer flow path PAb. That is, the flow path gradually expands in the up-down direction from the through-holes 304 and 303 to the buffer flow path PAb, and is provided radially. With respect to the flow direction of the cooling medium, the left guide portion 333 is provided so that the oxidant gas discharge flow path PA12 gradually reduces (so that the flow path is concentrated) from the buffer flow path PAb to the through-hole 303.

By providing the guide portion 333 upstream of the right buffer flow path PAb, the oxidant gas that has flowed through the oxidant gas supply flow path PA11 can be uniformly guided to the entire region in the up-down direction of the buffer flow path PAb. Since the buffer flow path PAb has a large flow path width, the flow speed of the oxidant gas that flowed to the buffer flow path PAb decreases. Furthermore, the oxidant gas collides with the convex portion 336 of the buffer flow path PAb and is dispersed in the up-down direction. In particular, since the convex portions 336 are arranged in a staggered manner over the entire region of the buffer flow path PAb, almost all of the oxidant gas is dispersed by the convex portions 336.

The oxidant gas thus can uniformly flow into the entire region in the up-down direction of the cathode flow path PAc by dispersing the oxidant gas that uniformly flowed into the buffer flow path PAb in the up-down direction by the convex portions 336. As a result, the power generation region can be substantially expanded, and the power generation performance can be improved. The oxidant gas that has passed through the cathode flow path PAc is dispersed in the up-down direction in the buffer flow path PAb, and is uniformly guided to the plurality of oxidant gas discharge flow paths PA12. As a result, the oxidant gas can be smoothly guided to the through-hole 303.

On the other hand, in a case where the convex portion 336 is not provided in the buffer flow path PAb, the oxidant gas that has flowed into the buffer flow path PAb flows into the cathode flow path PAc as it is. In this case, due to the positional relationship between the outlet of the oxidant gas supply flow path PA11 and the inlet of the cathode flow path PAc, the cathode flow path PAc into which the oxidant gas easily flows and the cathode flow path PAc into which the oxidant gas hardly flows exist. As a result, the flow of the oxidant gas in the cathode flow path PAc varies.

Although not illustrated, the plurality of convex portions 31 and concave portions 32, a metal bead seal (outer bead portion 331, individual bead portion 332), the guide portion 333, the convex portion 336, the tunnel portions 41 to 43, and the like are similarly formed on the rear surface 3Rb of the separator 3 (rear plate 3R) by press working the rear plate 3R. As a result, the fuel gas can be uniformly guided from the through-hole 301 to the entire region in the up-down direction of the anode flow path PAa via the tunnel portion 42, the guide portion 333, and the buffer flow path PAb. The fuel gas that has flowed through the anode flow path PAa is discharged from the through-hole 306 via the buffer flow path PAb, the guide portion 333, and the tunnel portion 42.

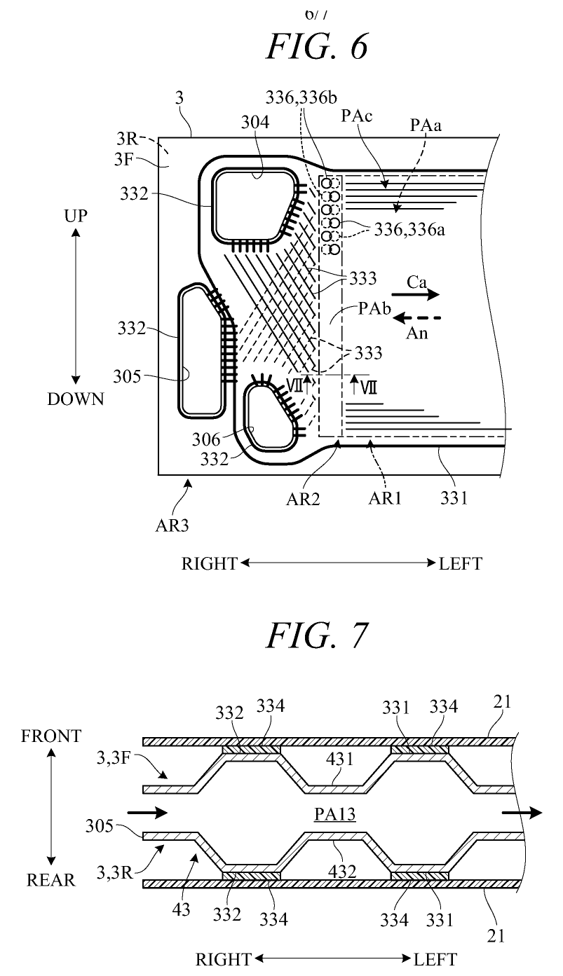

FIG. 6 is a diagram showing the guide portion 333 and the convex portion 336 (solid line) of the front plate 3F and the guide portion 333 and the convex portion 336 (dotted line) of the rear plate 3R in an overlapping manner on the right side (left side in the figure) of the separator 3. In FIG. 6, the flow direction of the oxidant gas in the cathode flow path PAc is indicated by a solid arrow Ca, and the flow direction of the fuel gas in the anode flow path PAa is indicated by a dotted arrow An.

As indicated by a dotted line in FIG. 6, in the inactive region AR3 of the separator 3 (rear plate 3R), a plurality of guide portions 333 are provided to protrude toward the frame 21 on the rear side, from the entire region in the up-down direction at the right end of the buffer flow path PAb continuing to the right end outlet of the anode flow path PAa to the through-hole 306. The plurality of guide portions 333 extend at equal intervals and are substantially parallel to each other. Therefore, the guide portion 333 of the rear plate 3R and the guide portion 333 of the front plate 3F extend so as to intersect each other. At this intersection, the rear end portion of the front plate 3F and the front end portion of the rear plate 3R partially abut on each other.

The convex portion 336 (dotted line) of the rear plate 3R is provided to be shifted in position by a half pitch in the up-down direction with respect to the convex portion 336 (solid line) of the front plate 3F. As a result, the convex portion 336 of the front plate 3F and the convex portion 336 of the rear plate 3R are arranged side by side in the left-right direction. The convex portion 336 of the rear plate 3R and the convex portion 336 of the front plate 3F may be provided at the same position in the up-down and left-right directions. That is, the convex portion 336 of the front plate 3F and the convex portion 336 of the rear plate 3R may be provided so as to overlap each other in a plan view in which the separator 3 is viewed from the thickness direction.

The flow of the cooling medium will be described. FIG. 7 is a cross-sectional view taken along line VII-VII of FIG. 4 illustrating the configuration of the tunnel portion 43 continuing to the through-hole 305. FIG. 7 also illustrates frames 21 (FIG. 3) disposed on the front side and the rear side of the separator 3. As illustrated in FIG. 7, the front end face of the individual bead portion 332 and the front surface of the outer bead portion 331 protruding toward the front side from the front plate 3F of the separator 3 are respectively abutted to the rear surface of the frame 21 via the seal member 334. The rear end face of the individual bead portion 332 and the rear end face of the outer bead portion 331 protruding toward the rear side from the rear plate 3R of the separator 3 are respectively abutted to the front surface of the frame 21 via the seal member 334.

The tunnel portion 43 extends to the right side from the through-hole 305 beyond the individual bead portion 332 and the outer bead portion 331. The tunnel portion 43 includes a front tunnel portion 431 bulging out toward the front side from the front plate 3F and a rear tunnel portion 432 bulging out toward the rear side from the rear plate 3R. A cooling medium supply flow path PA13 is formed between the front tunnel portion 431 and the rear tunnel portion 432, and the cooling medium flows from the right side to the left side as indicated by an arrow in FIG. 7 via the cooling medium supply flow path PA13. Although not illustrated, the tunnel portion 43 on the through-hole 302 side is similarly configured, and the cooling medium discharge flow path PA14 (FIG. 4) is formed between the front tunnel portion 431 and the rear tunnel portion 432.

Although FIG. 4 illustrates a plurality of tunnel portions 43, the configurations of the plurality of tunnel portions 43 are the same or substantially the same. As indicated by arrow A1 in FIG. 4, the cooling medium that has passed through the plurality of tunnel portions 43 flows to the left side through the back side (rear side) of the guide portion 333 and flows into the buffer region AR2.

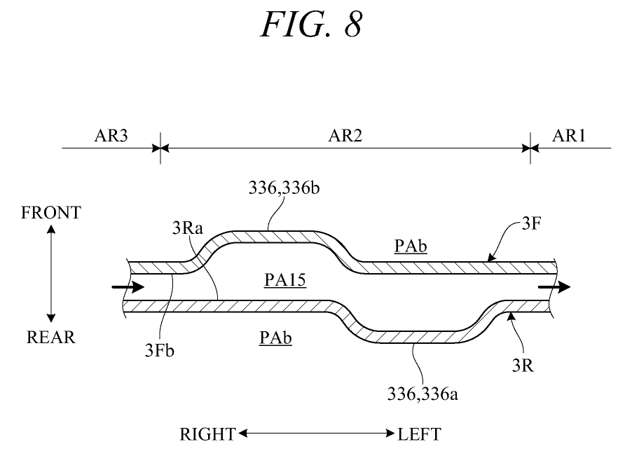

FIG. 8 is a cross-sectional view of the buffer region AR2 of the separator 3 (cross-sectional view taken along line VIII-VIII in FIG. 6). As illustrated in FIG. 8, in the buffer region AR2, the front plate 3F and the rear plate 3R are provided spaced apart from each other by a predetermined distance in the front-rear direction. As a result, the cooling medium supply flow path PA15 is formed between the rear surface 3Fb of the front plate 3F and the front surface 3Ra of the rear plate 3R. A right end portion of the cooling medium supply flow path PA15 communicates with the flow path on the back side of the guide portion 333 in the inactive region AR3, and a left end portion of the cooling medium supply flow path PA15 communicates with the cooling flow path PAw in the active region AR1.

The cooling medium supply flow path PA15 is provided over the entire buffer region AR2 in the up-down direction. As a result, the cooling medium smoothly flows through the entire region of the buffer region AR2, and the temperature rise of the cooling medium due to the flow of the cooling medium being hindered can be suppressed. That is, when the flow of the cooling medium is hindered, air bubbles may accumulate in the flow path of the cooling medium thus causing a temperature rise, but in the present embodiment, the accumulation of air bubbles in the flow path of the cooling medium from the inactive region AR3 to the active region AR1 can be suppressed, whereby the temperature rise can be suppressed.

Similarly to the right buffer region AR2, the left buffer region AR2 is also provided with the cooling medium discharge flow path PA16 (FIG. 4). The cooling medium flowing into the cooling flow path PAw via the cooling medium supply flow path PA15 flows to the left side along the cooling flow path PAw (FIG. 2), then flows to the left side through the back side (rear side) of the guide portion 333 as indicated by an arrow A2 in FIG. 4, and flows into the cooling medium discharge flow path PA16. Furthermore, the cooling medium passes through the cooling medium discharge flow path PA16 and then reaches the through-hole 302 via the tunnel portion 43.

In the buffer region AR2, the front plate 3F and the rear plate 3R are spaced apart from each other, but in the active region AR1, the rear surface 3Fb of the front plate 3F and the front surface 3Ra of the rear plate 3R abut on each other (FIG. 2). Although not illustrated, in the inactive region AR3 as well, the rear surface 3Fb of the front plate 3F and the front surface 3Ra of the rear plate 3R also abut on each other. Therefore, the front plate 3F and the rear plate 3R are spaced apart from each other only in the buffer region AR2 having a limited length in the left-right direction, and even if the plates 3F and 3R are spaced apart from each other, there is no problem in strength of the separator 3.

According to the present embodiment, the following operations and effects can be achieved.

(1) The fuel cell stack 100 is configured by alternately stacking the UEA 2 and the separator 3 in the front-rear direction (predetermined direction) (FIG. 1). The UEA 2 includes an MEA 20 having an electrolyte membrane and an anode electrode and a cathode electrode, and a frame 21 supporting a peripheral edge portion of the MEA 20 (FIG. 3). The separator 3 includes a front plate 3F having a front surface 3Fa and a rear surface 3Fb, and a rear plate 3R having a front surface 3Ra facing the rear surface 3Fb and a rear surface 3Rb, and is configured to form a cooling flow path PAw through which a cooling medium flows between the rear surface 3Fb of the front plate 3F and the front surface 3Ra of the rear plate 3R (FIG. 2). The front plate 3F is formed in an uneven shape so as to form a gas flow path (cathode flow path PAc etc.) through which an oxidant gas flows between the front surface 3Fa and the UEA 2 from the through-hole (communication hole) 304 on the right end side of the separator 3 penetrating the separator 3 to the through-hole (communication hole) 303 on the left end side of the separator penetrating the separator 3 (FIG. 2). The rear plate 3R is formed in an uneven shape so as to form a gas flow path (anode flow path PAa etc.) through which fuel gas flows between the rear surface 3Rb and the UEA 2 from a through-hole (communication hole) 301 on the left end side of the separator 3 penetrating the separator 3 to a through-hole (communication hole) 306 on the right end side of the separator 3 penetrating the separator 3 (FIG. 2). The gas flow path (e.g., the gas flow path of the front surface 3Fa of the front plate 3F) includes a cathode flow path PAc facing the MEA 20, an oxidant gas supply flow path PA11 and an oxidant gas discharge flow path PA12 extending from the through-hole 304 toward the inlet of the cathode flow path PAc and from the through-hole 303 toward the outlet of the cathode flow path PAc, and a buffer flow path PAb between the cathode flow path PAc and the oxidant gas supply flow path PA11 and between the cathode flow path PAc and the oxidant gas discharge flow path PA12 (FIG. 4). The region of the oxidant gas supply flow path PA11 and the region of the oxidant gas discharge flow path PA12 gradually expand from the through-hole 304 toward the inlet of the cathode flow path PAc and from the through-hole 303 toward the outlet of the cathode flow path PAc, that is, the oxidant gas supply flow path PA11 and the oxidant gas discharge flow path PA12 extend radially from the through-holes 304 and 303. The buffer flow path PAb includes a plurality of convex portions 336 protruding from the front surface 3Fa of the front plate 3F and the rear surface 3Rb of the rear plate 3R toward the UEA 2 in a state where the rear surface 3Fb of the front plate 3F and the front surface 3Ra of the rear plate 3R are spaced apart from each other (FIGS. 4 and 6).

With this configuration, the cooling medium smoothly flows through the buffer flow path PAb through the gap between the front plate 3F and the rear plate 3R. Therefore, air can be prevented from accumulating in the flow path of the cooling medium due to the flow of the cooling medium being hindered, and a good cooling effect can be obtained. When the oxidant gas supply flow path PA11 is configured radially, the flow of the oxidant gas into the cathode flow path PAc tends to be non-uniform, but by providing the buffer flow path PAb having the plurality of convex portions 336 between the oxidant gas supply flow path PA11 and the cathode flow path PAc, the oxidant gas can be uniformly guided to the cathode flow path PAc.

(2) The cathode flow path PAc extends along the axis line CL1, and the oxidant gas supply flow path PA11 extends along the axis line CL3 that diagonally intersects the axis line CL1 (FIG. 5). The cathode flow path PAc is provided more densely than the oxidant gas supply flow path PA11 (FIG. 5). In such a flow path configuration, it is difficult to uniformly guide the oxidant gas to the entire region of the cathode flow path PAc, but in the present embodiment, since the oxidant gas is guided to the cathode flow path PAc via the buffer flow path PAb having the plurality of convex portions 336, the oxidant gas can be uniformly guided to the entire region of the cathode flow path PAc.

(3) The oxidant gas supply flow path PA11 extends from the through-hole 304 toward the inlet of the cathode flow path PAc (FIG. 4). The flow path width W2 of the buffer flow path PAb is larger than the flow path width W3 of the oxidant gas supply flow path PA11. As a result, the flow speed of the oxidant gas decreases in the buffer flow path PAb, and the oxidant gas can be easily and uniformly guided to the cathode flow path PAc.

(4) The plurality of convex portions 336 are arrayed in a staggered pattern along the inlet and the outlet of the cathode flow path PAc, and are each formed in a substantially cylindrical shape (FIG. 4). As a result, the oxidant gas can be satisfactorily dispersed in the buffer flow path PAb, and the oxidant gas can be uniformly guided to the entire region of the cathode flow path PAc. In addition, the length of the buffer region AR2 provided in a state where the front plate 3F and the rear plate 3R are spaced apart from each other can be shortened, and sufficient strength of the separator 3 can be secured.

The above embodiment can be modified to various forms. Hereinafter, some modified examples will be described. In the above embodiment, the separator 3 is configured to form the cooling flow path PAw between the rear surface 3Fb and the front surface 3Ra by the front plate 3F as a first plate member having the front surface 3Fa (a first surface) and the rear surface 3Fb (a first opposite surface), and the rear plate 3R as a second plate member having the front surface 3Ra (a second opposite surface) and the rear surface 3Rb (a second surface), but the configuration of the first plate member and the second plate member is not limited to those described above. In the above embodiment, the separator 3 is configured in a concave-convex shape so as to form a gas flow path through which the oxidant gas flows from the through-hole 304 (a first communication hole) on the right end side (one end side) penetrating the separator 3 to the through-hole 303 (a second communication hole) on the left end side (another end side) penetrating the separator 3, and to form a gas flow path through which the fuel gas flows from the through-hole 301 (a first communication hole) on the left end side (one end side) penetrating the separator 3 to the through-hole 306 (a second communication hole) on the right end side (another end side) penetrating the separator 3, but the configuration of the separator is not limited to those described above.

In the above embodiment, the cathode flow path PAc is provided as a first gas flow path in the active region AR1 facing the MEA 20, the oxidant gas supply flow path PA11 and the oxidant gas discharge flow path PA12 are provided as a second gas flow paths in the inactive region AR3 extending radially from the through-hole 304 toward the inlet of the cathode flow path PAc and from the through-hole 303 toward the outlet of the cathode flow path PAc, and furthermore, the buffer flow path PAb is provided as a third gas flow path between the cathode flow path PAc and the oxidant gas supply flow path PA11 and between the cathode flow path PAc and the oxidant gas discharge flow path PA12. In this regard, the second gas flow path may be formed radially from the through-hole 304 toward the inlet of the cathode flow path PAc, or from the through-hole 303 toward the outlet of the cathode flow path PAc. In this case, the third gas flow path may be provided only between the first gas flow path and the radially formed second gas flow path.

In the above embodiment, the cathode flow path PAc is extended along the axis line CL1 (a first axis), and the oxidant gas supply flow path PA11 is extended along the axis line CL3 (a second axis) that obliquely intersects the axis line CL1 at a predetermined angle θ, but the directions in which the first gas flow path and the second gas flow path extend are not limited to those described above. In the above embodiment, the cathode flow path PAc is provided more densely than the oxidant gas supply flow path PA11, but the density relationship of each flow path is not limited to those described above. In the above embodiment, the flow path width W2 of the buffer flow path PAb is made larger than the flow path width W3 of the oxidant gas supply flow path PA11, but the relationship of the flow path widths of each flow path is not limited to those described above. In the above embodiment, the plurality of convex portions 336 are arranged in a staggered pattern in two rows in the left-right direction in the buffer region AR2, but a plurality of protruding portions may be in one row in the left-right direction or may be in three or more rows. In the above embodiment, the plurality of convex portions 336 in the buffer region AR2 are configured in a substantially cylindrical shape, but the shape of the plurality of protruding portions is not limited to those described above.

In the above embodiment, an example in which the fuel cell stack 100 is applied to a vehicle has been described, but a fuel cell stack having a power generation cell of the present invention can also be applied to mobile bodies other than vehicles such as aircraft and ships, robots, and various industrial machines.

The above embodiment can be combined as desired with one or more of the above modifications. The modifications can also be combined with one another.

According to the present invention, a good cooling effect can be obtained without obstructing a flow of a cooling medium.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack configured by alternately stacking a membrane electrode structure and a separator in a predetermined direction, wherein
the membrane electrode structure includes a membrane electrode assembly having an electrolyte membrane and electrodes, and a frame member supporting a peripheral portion of the membrane electrode assembly,
the separator includes a first plate member having a first surface and a first opposite surface, and a second plate member having a second surface and a second opposite surface facing the first opposite surface, and is configured to form a cooling flow path through which a cooling medium flows between the first opposite surface and the second opposite surface,
the first plate member and the second plate member are configured in a concave-convex shape so as to form gas flow paths through which a reaction gas flows between the first surface and the membrane electrode structure and between the second surface and the membrane electrode structure, respectively, from a first communication hole on one end side of the separator penetrating the separator to a second communication hole on another end side of the separator penetrating the separator,
each of the gas flow paths includes a first gas flow path facing the membrane electrode assembly, a second gas flow path extending from the first communication hole toward an inlet of the first gas flow path or from the second communication hole toward an outlet of the first gas flow path, and a third gas flow path between the first gas flow path and the second gas flow path, and
the third gas flow path includes a plurality of protruding portions protruding from the first surface and the second surface toward the membrane electrode structure, respectively, in a state where the first opposite surface and the second opposite surface are separated from each other.

2. The fuel cell stack according to claim 1, wherein
a region of the second gas flow path gradually expands from the first communication hole toward the inlet of the first gas flow path or from the second communication hole toward the outlet of the first gas flow path.

3. The fuel cell stack according to claim 1, wherein
the first gas flow path is extended along a first axis,
the second gas flow path is extended along a second axis obliquely intersecting the first axis, and
the first gas flow paths are provided at a higher density than the second gas flow paths.

4. The fuel cell stack according to claim 1, wherein
the second gas flow path extends from the first communication hole toward the inlet of the first gas flow path, and
a flow path width of the third gas flow path is larger than a flow path width of the second gas flow path.

5. The fuel cell stack according to claim 1, wherein
the plurality of protruding portions are arranged in a staggered pattern along the inlet or the outlet of the first gas flow path, and
each of the plurality of protruding portions is formed in a substantially cylindrical shape.

6. The fuel cell stack according to claim 5, wherein
an end portion of the membrane electrode assembly is located at an intermediate position of the third gas flow path.

7. The fuel cell stack according to claim 2, wherein
a pair of the second gas flow paths extend from the first communication hole toward the inlet of the first gas flow path and from the second communication hole toward the outlet of the first gas flow path, and
regions of the pair of the second gas flow paths gradually expands from the first communication hole toward the inlet of the first gas flow path and from the second communication hole toward the outlet of the first gas flow path.
